(19) United States
(12) Patent Application Publication
(10) Pub. No.: US 2012/0236135 A1
(43) Pub. Date: Sep. 20, 2012

(54) Intraoral Occlusion Measurement and Registration

(75) Inventors: Yitzhak Daniel, Givat Ze'ev (IL); Karol Sanilevici, Jerusalem (IL); Michael Doherty, Peabody, MA (US); Alex Entelis, Maale Edumim (IL)

(73) Assignee: OPTIMET, OPTICAL METROLOGY LTD., Jerusalem (IL)

(21) Appl. No.: 13/418,730

(22) Filed: Mar. 13, 2012

Related U.S. Application Data
(60) Provisional application No. 61/465,062, filed on Mar. 14, 2011.

(51) Int. Cl. H04N 7/18

(52) U.S. Cl. 348/66; 348/E07.085

(57) ABSTRACT

Methods and apparatus for registration of digital images of a plurality of dental surfaces of a patient. Multiple dental surfaces are separately scanned and digitized, where each of the surfaces has at least one marked area. All marked areas are optically acquired, creating digitized images of the plurality of dental surfaces, which are then registered in a common reference frame on the basis of a specified marked areas. In some cases, a first dental surface is disposed on an upper dental arch and a second dental surface is disposed on a lower dental arch. Marked contact areas may be indicative of local occlusion pressure.

The present Application claims the priority of U.S. Provisional Patent Application Ser. No. 61/465,062, filed Mar. 14, 2011, and incorporated herein by reference.

### FIELD OF INVENTION

Embodiments of the present invention relate to dental measurement methods, apparatus, and computer program products, and, more particularly, to apparatus and methods for determining regions of occlusion contact in the bite of a patient in three dimensions.

### BACKGROUND ART

Occlusal analysis plays a significant role in various aspects of dental care and treatment. An understanding of how a prosthesis will impact occlusion, for example, is critical to effective design of the prosthesis. Since prosthetic dentistry is increasingly digital, a dental practitioner is faced with the problem of transferring the occlusion situation of the closure of the upper and lower (mandible and maxilla) jaws into a digital form such that it may be operated upon by computer-aided design (CAD) software. In particular, the occlusion situation must be known in three dimensions for proper design of the external shape and morphology of a dental crown or dental bridge that will have an optimal occlusion (i.e., mouth closure) when placed in the patient's mouth.

In typical CAD procedures, each of the arches is scanned by a 3D scanner separately. The 3D occlusion situation is complicated and hard to replicate, moreover, it is difficult to approximate automatically by mathematical or software tools because it is dependent on the irregularities of the shape of a patient's individual mouth and teeth.

One class of existing technique for occlusion capture entails the casting of a gypsum model, which, in turn, may be scanned using a coordinate measuring machine (CMM) or desktop scanner. One issue is the proper registration of the two arches. In one technique, 3D scans are performed of a gypsum cast as well as of a silicon/polymer bite, taken by the dentist, mounted on the gypsum cast. Registration of the cast based on the bite provides a 3D image of the both jaws when closed. A silicon bite, however, as an object reflection the shape and position of the opposite jaw, has thickness which might not exist when the jaws closes in its absence, moreover, it is characterized by its own in-accuracy (including the bite taking procedure) which depends, in turn, on the qualities of the material and morphology of the bite. For example, the bite material may be torn or may deform where it is very thin.

In other known techniques, gypsum casts are scanned together with mechanical fixtures of a mechanical dental articulator, used to for manual articulation, by a technician, of the two gypsum models of the upper and lower jaw. A 3D scan of the pre-defined fixture connected to both the upper and lower jaw, is then registered in order to obtain the actual closure between the two arches.

Alternatively, other registration features may be added to the upper and lower jaws in pre-defined 3D relation after the jaws are articulated, in which case the registration features are scanned along with the features of each jaw. The upper and lower cast jaw models may also be scanned together from the sides, after articulation and closure of the jaw. Side scanning, however, has its own uncertainly and also has to be further registered to the lower and the upper jaw, each with its own inaccuracy.

In some techniques, the jaws scans are virtually manipulated relative to each other using 3D software, thereby determining contact points and closure. Other techniques employ 3D scans for the side of the teeth in the patient's mouth while the jaws are closed, and then register separate measurements of the upper and lower arches to the “side scan,” with varying degrees of manual intervention. A further technique entails scanning a silicon bite (top bite) mounted on the tooth in the area of interest, followed by registration of the bite with the jaw, the bite and the opposite jaw.

Dynamic occlusion may studied by manipulating the jaws scans, one in relation to the other, by means of 3D software and determining contact points, thus effectuating a “virtual articulator”.

Scanning of a temporary restoration after being shaped manually by the dentist, and the temporary may be digitized, as taught in Patent Application WO 2009/122402, of Optimet Optical Metrology Ltd. The shape of the temporary already embodies the occlusion situation and the morphology of the top part of the temporary restoration may serve as the source of occlusion data.

### SUMMARY OF EMBODIMENTS OF THE INVENTION

In accordance with preferred embodiments of the present invention, methods and apparatus are provided for registration of digital images of a plurality of dental surfaces of a patient. One embodiment of the method has steps of:
a. separately scanning and digitizing a plurality of dental surfaces of the patient, each of the dental surfaces including at least one marked area;
b. optically acquiring each marked area for generating a digital image; and
c. registering the digitized images of the plurality of dental surfaces in a common reference frame on the basis of a specified marked area.

In accordance with some embodiments of the present invention, the step of optically acquiring each marked area may include identifying the marked area within a three-dimensional scan of the dental surfaces. In various embodiments of the invention, as well, marking may be effected by virtue of contact between the first dental surface and a second dental surface, the first and second dental surfaces disposed, respectively, on upper and lower dental arches of the patient. The first dental surface may be disposed on a upper dental arch and a second dental surface is disposed on a lower dental arch.

Alternatively, or additionally, the step of marking an area may include creating a marked contact area indicative of local occlusion pressure. The step of optically acquiring may include mapping an intensity of color indicative of local occlusion pressure. The dental surface may also be manually marked, within the scope of the present invention. In particular, marking, of any sort, may be performed prior to preparation of a tooth for fitting a prosthesis.

In other embodiments of the invention, an apparatus is provided for performing any of the methods heretofore listed. The apparatus has an optical scanner for separately scanning and digitizing a plurality of dental surfaces of the patient, each of the dental surfaces including at least one marked area, the optical scanner generating a scanning signal associated with each of plurality of pixels associated with the dental surface. The apparatus also has a reflection level threshold filter, for discriminating pixels corresponding to a marked area and a processor for registering the digitized images of the plurality of dental surfaces in a common reference frame on the basis of the marked area.

In accordance with yet further embodiments of the invention, a non-transitory computer-readable medium for use on a computer system for extracting occlusion data from digital scanning data, the non-transitory computer readable medium having computer-readable program code thereon, the computer-readable program code comprising:
a. a computer code module for digitizing each of upper and lower dental arches of a patient;
b. a computer code module for registering digitized images of the upper and lower dental arches in a common reference frame on the basis of digitized marked contact areas between the dental arches.

The non-transitory computer-readable medium may also have a computer code module for mapping an intensity indicative of local occlusion pressure.

### BRIEF DESCRIPTION OF THE DRAWINGS

The foregoing features of the invention will be more readily understood by reference to the following detailed description taken with the accompanying drawings, in which:

FIGS. 1A and 1B depict 3D scans of portions of the mouth of a patient after marking of occlusion contact points with articulation paper, in accordance with embodiments of the present invention;

FIG. 2 shows the scans of contact areas isolated from the underlying tooth surface by filtering out measurement points on the basis of reflection level detected at a sensor, in accordance with embodiments of the present invention;

FIG. 3 shows the occlusion registration of two scans in 3D based on occlusion marked points in accordance with a further embodiment of the present invention; and

FIGS. 4A and 4B compare reflection in cases where the normal to the dental surface is closer to, or further from, the direction between the surface and the scanner, respectively.

### DESCRIPTION OF SPECIFIC EMBODIMENTS OF THE INVENTION

In accordance with embodiments of the present invention, contact regions of teeth of the respective upper and lower jaws are marked in situ, and the markings are then used as the basis for deriving a digital representation of one or more aspects of the occlusal situation of a dental patient. Markings are obtained by a dentist or dental technician marks on teeth of either the upper or lower jaw, or, preferably, both, with the jaw partially closed together with the patient biting on articulation paper, or by any other means of directly marking in the patient's mouth.

Definition: As used herein, and in any appended claims, the terms “contact point” and “contact area” shall be used interchangeably, unless the context requires otherwise. It is to be recognized that the region of contact between one tooth and another may be smaller or larger, depending on tooth morphology and closure pressure, and that use of the term “point” is not intended to imply that the region of contact is smaller than the spatial resolution of the scanning modality.

Alternatively, rather than marking teeth in the mouth of a patient, a dental practitioner may mark the closure of the two jaws in “an occlusion-like” situation as above, but on two gypsum casts models mounted and articulated by a dedicated mechanical articulator such, for example, as those manufactured by KaVo, of Biberach/Riss, Germany, or by Amann Girrbach, of Koblach, Austria.

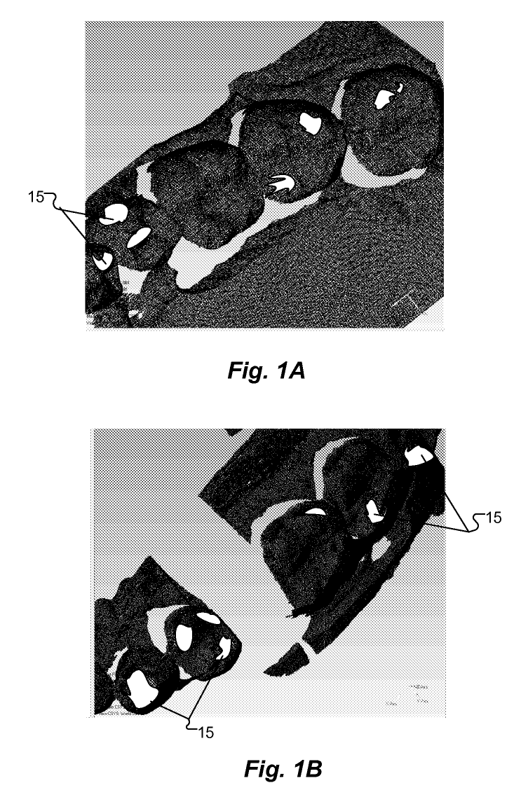

In either of the foregoing cases (intraoral, and marking of a cast), marking may be performed with “articulating paper,” such as that sold by Dr. Jean Bausch KG of Cologne, Germany. The articulating paper is inserted by the dental practitioner into the patient's mouth, and then patient's jaws are closed on the marking paper. The articulating paper leaves color stains 15 (depicted as white regions in FIGS. 1A and 1B) on the contact point/areas of the teeth according to the natural occlusion in the patient mouth or based on articulation of two cast models.

Further within the scope of the present invention, progressive articulating papers may be employed, which transfer color to the tooth surfaces with the color shade based on the occlusion pressure. An example of such a product is PROGRESS 100® articulating paper, sold by Bausch Articulating Papers, Inc., of Nashua, N.H., USA.

Contact points are mostly present in molar and pre-molar teeth. Typically, there are several such marked contact points on each jaw.

After marking the occlusion contact point, a 3D scan of both upper and lower teeth is done by either a 3D intra-oral scanner or, on gypsum models, by a desktop 3D dental scanner. Three-dimensional scans may be represented in STL file format, for example, for processing by CAD systems. 3D scans of a portion of the mouth of a patient are shown in FIGS. 1A and 1B.

In accordance with preferred embodiments of the invention, measurement data include, for each measured point on the dental object or teeth, both the 3D coordinates of the dental surface and the amount of energy/light reflected back to the sensor for each measured point. Such data are provided, for example, using an intraoral imaging system based on conoscopic holography, as described in US Patent Application 2009/0231649 (to Sirat), which is incorporated herein by reference. In accordance with certain embodiments of the present invention, a conoscopic profilometer is provided, i.e., a device, such as described in U.S. Pat. No. 7,375,827 (to Agronik, et al.) for determining the distance from a fiducial reference point to each of a set of points on a specified surface. U.S. Pat. No. 7,375,827 is also incorporated herein by reference.

Various 3D measurement scanners and sensors are capable of detecting information regarding the amount of light returned to the sensor from dental surfaces. The amount of light is dependent upon, among other factors, the shade or color of the surface changing the amount of light emitted by the scanner onto the surface and reflected back to the sensor. The amount of light reflected back is also dependent on the angle of the surface in relation to the direction of the measurement beam, a direction that may be referred to, herein, as the “normal,” in that it is substantially normal to the average surface of the teeth facing the scanner

The reflection level (i.e., the intensity of light returned to the sensor from the dental surface) is considered in relation to the color or shade of the dental surface being scanned. The shade, as discussed above, at the marked contact points, is darker that the background dental surface, or may colored by the articulating paper. This allows marked areas to be identified, and has the effect of “coloring” each measured point in 3D which is in a contact area. Colored or marked tooth surfaces in dark shades will have a lower amount of energy (conoscopic signal level, in the case of conoscopic scanning, or less energy reflected back to the scanner, in non-interferometric scanning technologies) in relation to the unmarked tooth surfaces.

Once a scan of each of the arches has been obtained, each scan is then processed to obtain the following features:
Global 3D surfaces of the teeth;
A “color” ranking for each measured point, indicating whether each point exceeds a specified threshold intensity level.

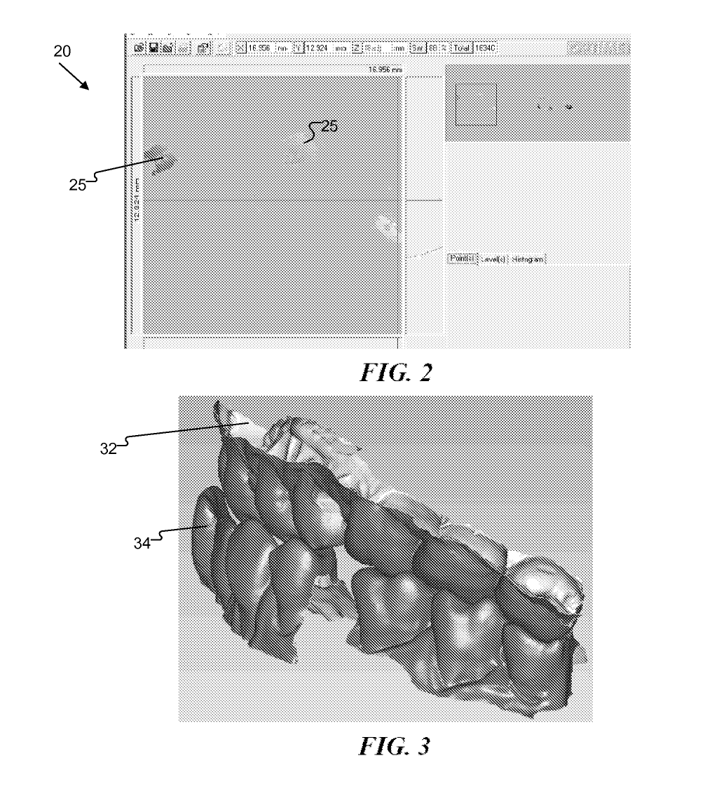

An apparatus in accordance with preferred embodiments of the present invention includes a reflection intensity threshold filter for discriminating pixels corresponding to areas of the dental surface that have been marked as contact areas, or otherwise marked, as described above. The reflection intensity threshold filter may be implemented in hardware or software, and the threshold level for filtering may be set automatically or by an operator. By applying dynamic filters and rankings relative to the entire data set, the 3D surface of contact points and areas 25 may be isolated from other scanned regions of surrounding teeth, as shown in FIG. 2. This allows the 3D surface of contact points and areas to be isolated from other scanned regions. Alternatively, a progressive “map” 20 of the 3D contact areas ranked by the intensity of the color which is relative to the occlusion pressure.

The two sets of the isolated 3D surfaces of the contact areas 15 (shown in FIGS. 1A and 1B) of the upper and lower jaws are registered, using standard 3D algorithms, or otherwise, in such a manner that these surfaces are in the closest proximity. Registration may be in a common frame of reference defined by a specified marked area. A composite 3D image of the upper 32 and lower 34 dental arches is shown in FIG. 3, after registration using contact areas, as taught in the present invention. Such registration simulates the original occlusion situation in the patient mouth. The progressive “map” on the 3D digital surfaces based on the occlusion marks shades may be used additionally to indicate the amount of occlusion pressure in each contact point or surface on the 3D data.

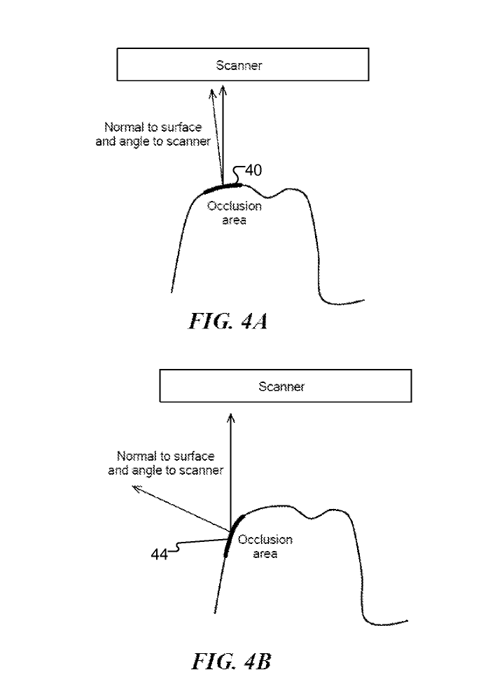

In accordance with further embodiments of the present invention, an additional parameter can be used, namely the angle of the normal to the tooth surface relative to the scanner. The normal to the tooth surface is calculated and weighted in order to correct the light reflection intensity (shade) analysis of the entire surface and the colored contact points. The amount of light or energy reflected back to the scanner is also dependent on the angle of the surface being scanned in relation to the 3D scanner. A flat tooth surface 40 (in relation to the scanning orientation), as shown in FIG. 4A, will reflect back larger amount of light while a steep surface or tooth wall 44, shown in FIG. 4B, will reflect smaller amount of energy to the scanner direction. Therefore, as an example, “darker” area on a flat surface indicates more color area than a “darker” area on a steep surface.

Isolation and identification of contact points or areas may be enhanced using video images taken by a two-dimensional (2D) video camera, mounted, for example, on the scanner. The video images, which also contain the distinct colored contact areas (in 2D), are registered to the 3D data. This allows further enhancement of the distinction of the contact points in addition to the distinction determined on the basis of the amount of light reflected back to the 3D scanner and the 3D data.

In accordance with further embodiments of the invention, the dental practitioner may enhance or mark the most distinct contact points with a marking tool after the standard occlusion procedure (with articulating paper) is done. The number of such points marked by the dentist or technician can vary (for example. between 3-7 points on each side of the jaw). This marking minimizes the amount of occlusion colored points for easier data handling and registration or in order to mark the most important occlusal points as determined by the dentist.

Alternatively, a specific occlusion marking tool may be used for manual marking of one or more dental surfaces for CAD occlusion registration purposes, or for other CAD of computer-aided manufacture (CAM) registration purposes.

The registration algorithm may include (i) a Least Squares Method (LSM) between the occlusion-marked surfaces; (ii) finding the center of each the occlusion area and registration of such point to the opposite point in LSM; (iii) including parameters as above weighted data based on the surface angulations and normals; (iv) other registration method as applied in off-the-shelf software packages such as Rapidform, supplied by INUS Technology, Inc., of Seoul, South Korea, or Geomagic, supplied by Geomagic US, Research Triangle, NC, and others. Registration may also be achieved by moving the 3D images in the computer software viewer close to each other while the marked areas are in closest proximity. Alternatively, computerized registration of both jaws may be achieved by pointing (by mouse or other pointer) manually on the occlusal areas on both jaws images and then registration by the computerized algorithm as above, by least squares, or otherwise.

Since both the full 3D scans, and the 3D scans that have been filtered to contain the contact areas, are derived from the same data, and, even if separated into two data sets, the corresponding scans are still rendered in the same coordinate system. This allows for the occlusion of the contact marked areas to bring together the full 3D scan of both jaws, as well, in the same position and orientation. The result is 3D positioning the scans of the upper and lower jaws in relation one to the other and the contact points between the teeth as marked by the dentist, optionally together with the progressive map. It should be noted that the occlusion obtained is in real 3D, and not only in simple contact points (in two dimensions), since the color marking can be also on angulated surfaces.

The above process can be repeated in another retention position of the jaws, thereby providing retention simulation and contact points/areas of the two jaws in more than one point and in jaw movement and retention.

In accordance with other embodiments of the invention, the 3D scan, obtained as described above, may be considered in conjunction with the articulated 3D information of the opposite jaw. Such information may assist in designing full contour crowns while having exact information on the opposite jaw.

A further application of the acquisition and filtering of three dimensional scans of contact points or areas is the use of the contact points or areas as fiducial references for registering partial scans of different regions of the mouth, where contact points or areas are common to distinct partial scans.

The information with respect to contact area, obtained in accordance with the teachings of the present invention, derives its accuracy from its basis on the actual contact points of the teeth surface while in closure, and not from indirect bites or side scans. Thus, when compared with existing methods and techniques, the present invention may advantageously provide direct and actual data on the position and area of the contact points (between opposing teeth that touch one another). In the methods described herein, the occlusion marking has no detectable thickness and is not subject to the material dependency of a silicone bite.

Methods as described herein may be employed advantageously prior to preparation of a tooth for fitting a crown or a bridge, or other dental prosthesis. In this way, the original occlusion situation is marked, and measured in three dimensions, on the original natural morphology of the tooth, prior to any removal of tooth material as the tooth is prepared for a crown. This procedure applies when a significant part of the natural morphology of the tooth exists prior to preparation, so that the original tooth may provide additional information for the occlusion situation. The additional information provided by the original tooth (in particular, the occlusion contact points with the antagonist teeth and jaw) may then be used in designing the external shape of the crown or bridge.

It is to be understood that operation of the embodiments of the invention requires programmable computer instructions, configuration, and support embodying all or part of the functionality previously described with respect to the invention and loaded onto a computer. Those skilled in the art should appreciate that such computer instructions and support can be written in a number of programming languages for use with many computer architectures or operating systems. For example, some embodiments may be implemented as entirely software (e.g., a computer program product) in a procedural programming language (e.g., “C”) or an object oriented programming language (e.g., “C++”). Furthermore, such instructions may be stored in any non-transitory computer medium such as a memory device, more particularly semiconductor, magnetic, optical or other memory devices, and may be either transmitted to the computer using any communications technology (such as optical, infrared, microwave, or other transmission technologies) or embedded in it in a form of a programmable hardware chip with a computer program product fixed in it. It is expected that such a computer program product may be distributed as a removable storage medium with accompanying printed or electronic documentation (e.g., shrink wrapped software), preloaded on the computer (e.g., on a computer ROM or fixed disk), or distributed from a server or electronic bulletin board over the network (e.g., the Internet or World Wide Web). Of course, some embodiments of the invention may be implemented as a combination of both software and hardware. Still other alternative embodiments of the invention can be implemented as pre-programmed entirely hardware elements.

The embodiments of the invention heretofore described are intended to be merely exemplary and numerous variations and modifications will be apparent to those skilled in the art, including various combinations of four different methods that have been described. All such variations and modifications are intended to be within the scope of the present invention as defined in any appended claims.

What is claimed is:

1. A method for registration of digital images of a plurality of dental surfaces of a patient, the method comprising:
a. separately scanning and digitizing a plurality of dental surfaces of the patient, each of the dental surfaces including at least one marked area;
b. optically acquiring each marked area for generating a digitized image; and
c. registering all the digitized images of the plurality of dental surfaces in a common reference frame on the basis a specified marked area.

2. A method in accordance with claim 1, wherein the step of optically acquiring the marked area includes identifying the specified marked area in a three dimensional scan of the dental surfaces.

3. A method in accordance with claim 1, wherein marking is effected by virtue of contact between a first dental surface and a second dental surface, the first and second dental surfaces disposed, respectively, on upper and lower dental arches of the patient.

4. A method in accordance with claim 1, wherein a first dental surface is disposed on a upper dental arch and a second dental surface is disposed on a lower dental arch.

5. The method of claim 1, wherein the step of marking an area includes creating a marked contact area indicative of local occlusion pressure.

6. The method of claim 5, wherein the step of optically acquiring includes mapping an intensity of color indicative of local occlusion pressure.

7. The method of claim 1, further comprising supplementarily marking a dental surface manually.

8. The method of claim 1, wherein marking is performed prior to preparation of a tooth for fitting a prosthesis.

9. An apparatus for performing any of the methods claimed in claims 1-8, the apparatus comprising:
a. an optical scanner for separately scanning and digitizing a plurality of dental surfaces of the patient, each of the dental surfaces including at least one marked area, the optical scanner generating a scanning signal associated with each of plurality of pixels associated with the dental surface;
b. a reflection level threshold filter, for discriminating pixels corresponding to a marked area; and
c. a processor for registering the digitized images of the plurality of dental surfaces in a common reference frame on the basis of the marked area.

10. A non-transitory computer-readable medium for use on a computer system for extracting occlusion data from digital scanning data, the non-transitory computer readable medium having computer-readable program code thereon, the computer-readable program code comprising:
a. a computer code module for digitizing each of upper and lower dental arches of a patient;
b. a computer code module for registering digitized images of the upper and lower dental arches in a common reference frame on the basis of digitized marked contact areas between the dental arches.

11. The non-transitory computer-readable medium of claim 10, further comprising a computer code module for mapping an intensity indicative of local occlusion pressure.
